(19) United States
(12) Patent Application Publication
(10) Pub. No.: US 2019/0272949 A1
(43) Pub. Date: Sep. 5, 2019

(54) COIL COMPONENT AND COIL INSULATING MEMBER

(71) Applicant: Yazaki Corporation, Tokyo (JP)

(72) Inventors: Chiaki CHIDA, Shizuoka (JP); Akinori MARUYAMA, Shizuoka (JP)

(73) Assignee: Yazaki Corporation, Tokyo (JP)

(21) Appl. No.: 16/413,864

(22) Filed: May 16, 2019

Related U.S. Application Data
(63) Continuation of application No. PCT/JP2017/037027, filed on Oct. 12, 2017.

(30) Foreign Application Priority Data
Dec. 21, 2016 (JP) 2016-247604

(51) Int. Cl. H01F 27/32; H01F 27/29

(52) U.S. Cl. CPC H01F 27/325; H01F 27/29

(57) ABSTRACT

A coil component and an insulating bobbin are provided with a first insulating bobbin having a first flange portion, a first rib, and a pair of locking claw portions and a second insulating bobbin having a second flange portion, a second rib, and a pair of locking opening portions. The pair of locking claw portions and the pair of locking opening portions are locked in a state where both end portions of a coil winding portion in a coil axis direction are covered with the first and second flange portions and and the first and second ribs and are respectively fitted into first and second slits and of the coil winding portion. As a result, adequate insulation performance can be ensured and workability can be improved when a coil insulating member is assembled to the coil winding portion.

### CROSS-REFERENCE TO RELATED APPLICATION

This application is a continuation application of International Application PCT/JP2017/037027, filed on Oct. 12, 2017 which claims the benefit of priority from Japanese Patent application No. 2016-247604 filed on Dec. 21, 2016 and designating the U.S., the entire contents of which are incorporated herein by reference.

### BACKGROUND OF THE INVENTION

### 1. Field of the Invention

The present invention relates to a coil component and a coil insulating member.

### 2. Description of the Related Art

In the related art, a coil component is used in, for example, a transformer of a switching power supply device or the like. This coil component is provided with a coil winding portion and a bobbin insulating the coil winding portion from other electronic components and the like. In the coil component, the bobbin is assembled to the coil winding portion and covers the upper and lower surfaces of the coil winding portion in a coil axis direction. The coil winding portion is insulated as a result (see, for example, Japanese Patent Application Laid-open No. 2014-165279).

In some cases, the coil winding portion of the coil component is pinched from the coil axis direction by first and second bobbins and the coil winding portion is insulated from both sides in the coil axis direction so that adequate insulation performance is ensured. In this case, workability needs to be improved during the assembly of the first and second bobbins to the coil winding portion. There is room for further improvement in this regard.

### SUMMARY OF THE INVENTION

The present invention has been made in view of the above, and an object of the present invention is to provide a coil component and a coil insulating member allowing workability to be improved when the coil insulating member is assembled to a coil winding portion while ensuring adequate insulation performance.

In order to solve the above mentioned problem and achieve the object, a coil component according to one aspect of the present invention includes a coil winding portion formed by a single conductor being wound more than once around a coil axis, a first slit being formed in one end portion of the coil winding portion in a coil axis direction along the coil axis and a second slit being formed in the other end portion of the coil winding portion in the coil axis direction by the conductor being wound; a first insulating member including an annular first covering member covering the one end portion of the coil winding portion, a first tube portion extending from an inner edge of the first covering member to the coil winding portion side along the coil axis direction and inserted inside the coil winding portion, a first protruding portion provided on the coil winding portion side of the first covering member and fitted into the first slit, and a first locking portion provided in the first tube portion; and a second insulating member including an annular second covering member covering the other end portion of the coil winding portion, a second tube portion extending from an inner edge of the second covering member to the coil winding portion side along the coil axis direction and inserted inside the coil winding portion, a second protruding portion provided on the coil winding portion side of the second covering member and fitted into the second slit, and a second locking portion provided in the second tube portion and locked in the first locking portion in a state where the first protruding portion is fitted into the first slit and the second protruding portion is fitted into the second slit.

According to another aspect of the present invention, in the coil component, it is preferable that the coil winding portion includes: a first winding portion formed in an ended ring shape and having the first slit formed by one end portion and the other end portion in a circumferential direction about the coil axis; a second winding portion formed in an ended ring shape and having the second slit formed by one end portion and the other end portion in a circumferential direction about the coil axis; and a connecting portion interconnecting the one end portion of the first winding portion and the other end portion of the second winding portion along the coil axis direction in a positional relationship in which the first winding portion and the second winding portion are spaced apart from each other along the coil axis direction.

According to still another aspect of the present invention, in the coil component, it is preferable that the first insulating member and the second insulating member are provided such that: the first tube portion is inserted inside the second tube portion; one of the first tube portion and the second tube portion has a projecting portion; the other of the first tube portion and the second tube portion has a third slit formed along the coil axis direction; and the projecting portion is fitted into the third slit at a position where the first locking portion and the second locking portion are locked.

In order to achieve the object, a coil insulating member according to still another aspect of the present invention includes a first insulating member including an annular first covering member covering one end portion of a coil winding portion, a first tube portion extending from an inner edge of the first covering member to the coil winding portion side along a coil axis direction and inserted inside the coil winding portion, a first protruding portion provided on the coil winding portion side of the first covering member and fitted into a first slit, and a first locking portion provided in the first tube portion, the coil winding portion being formed by a single conductor being wound more than once around a coil axis, the first slit being formed in the one end portion of the coil winding portion in the coil axis direction along the coil axis, and a second slit being formed in the other end portion of the coil winding portion in the coil axis direction by the conductor being wound; and a second insulating member including an annular second covering member covering the other end portion of the coil winding portion, a second tube portion extending from an inner edge of the second covering member to the coil winding portion side along the coil axis direction and inserted inside the coil winding portion, a second protruding portion provided on the coil winding portion side of the second covering member and fitted into the second slit, and a second locking portion provided in the second tube portion and locked in the first locking portion in a state where the first protruding portion is fitted into the first slit and the second protruding portion is fitted into the second slit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a configuration example of a coil component according to an embodiment;

FIG. 2 is a cross-sectional view taken along line X-X of FIG. 1, which illustrates the configuration example of the coil component according to the embodiment;

FIG. 3 is an exploded perspective view illustrating the configuration example of the coil component according to the embodiment;

FIG. 4 is a perspective view illustrating a configuration example of a first insulating bobbin according to the embodiment; and

FIG. 5 is a perspective view illustrating a configuration example of a second insulating bobbin according to the embodiment.

### DETAILED DESCRIPTION OF THE PREFERRED EMBODIMENTS

A mode (embodiment) for carrying out the present invention will be described in detail with reference to accompanying drawings. The present invention is not limited by the content described in the following embodiment. In addition, the following constituent elements include those that can be easily assumed by those skilled in the art and those that are substantially identical. Further, the configurations described below can be appropriately combined. In addition, various omissions, substitutions, or changes in configuration can be made without departing from the gist of the present invention.

### Embodiments

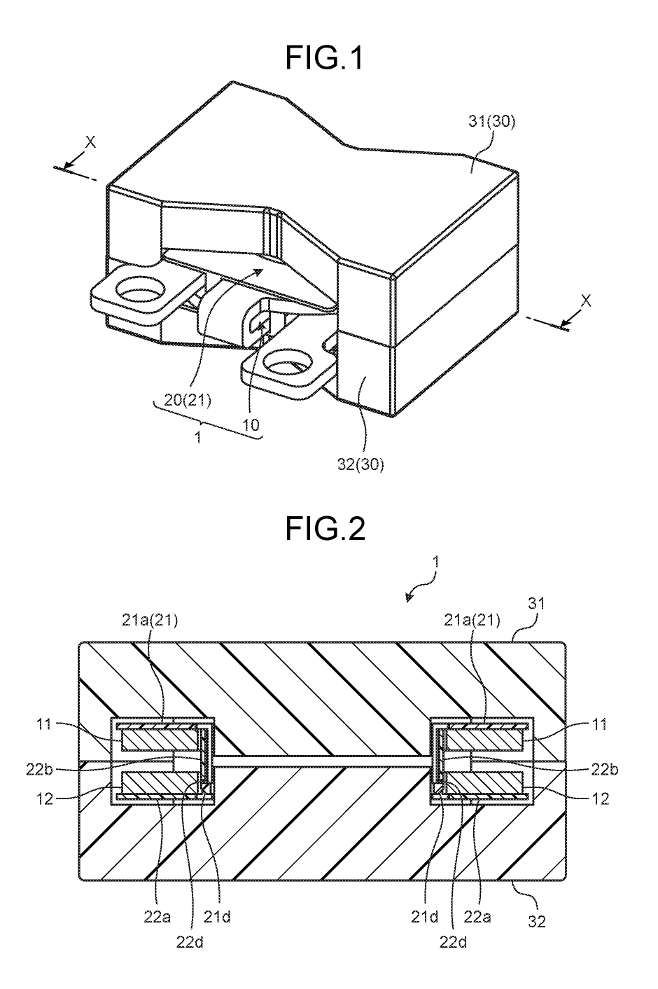

A coil component 1 and an insulating bobbin 20 according to the embodiment will be described below. The coil component 1 is, for example, a component used for a transformer of a switching power supply device or the like. As illustrated in FIG. 1, the coil component 1 is provided with a coil winding portion 10, the insulating bobbin 20 as a coil insulating member, and a pair of core members 30.

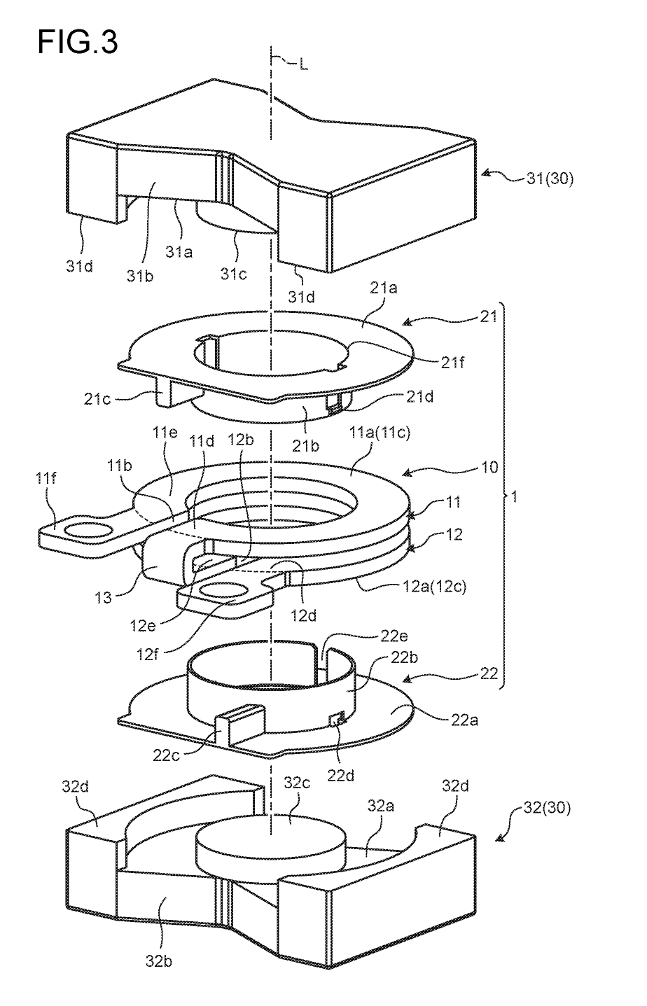

The coil winding portion 10 is a coil formed by a single conductor being wound more than once around a coil axis L. As illustrated in FIGS. 2 and 3, in the present embodiment, the coil winding portion 10 is formed by a flat plate-shaped linear conductor being wound twice around the coil axis L. The coil winding portion 10 has a first winding portion 11, a second winding portion 12, and a connecting portion 13. In the coil winding portion 10, the first winding portion 11 and the second winding portion 12 are spaced apart from each other along the coil axis L direction and the first winding portion 11 and the second winding portion 12 are connected to each other by the connecting portion 13. Here, the coil axis L direction is a direction along the coil axis L. In the coil winding portion 10, a first slit 11b is formed in a first annular end surface 11a as an end portion on one side in the coil axis L direction and a second slit 12b is formed in a second annular end surface 12a as an end portion on the other side in the coil axis L direction by the conductor being wound.

The first winding portion 11 is formed in an ended ring shape. In other words, the first winding portion 11 is formed such that both tip portions of the conductor in the direction in which the conductor extends are spaced apart from each other by the conductor being annularly wound about the coil axis L direction and along a coil axis orthogonal direction, which is orthogonal to the coil axis L. When viewed from the coil axis L direction, the first winding portion 11 is formed in a C shape and is formed in a flat plate shape perpendicular to the coil axis L direction. The first winding portion 11 has a first axis portion main body 11c, a first terminal end portion 11d as an end portion on one side in a circumferential direction about the coil axis L, and a first starting end portion 11e as an end portion on the other side in the circumferential direction about the coil axis L. In the first axis portion main body 11c, the first slit 11b is formed by the first starting end portion 11e and the first terminal end portion 11d facing each other. The first slit 11b has a shape in which the first axis portion main body 11c is cut along the coil axis orthogonal direction. In the first winding portion 11, a first terminal portion 11f is provided in the first starting end portion 11e. In addition, in the first winding portion 11, the first terminal end portion 11d is connected to the second winding portion 12 by the connecting portion 13.

The second winding portion 12 is formed in an ended ring shape. In other words, the second winding portion 12 is formed such that both tip portions of the conductor in the direction in which the conductor extends face each other and are spaced apart from each other by the conductor being annularly wound about the coil axis L direction and along a coil axis orthogonal direction. When viewed from the coil axis L direction, the second winding portion 12 is formed in a C shape, is formed in a flat plate shape perpendicular to the coil axis L direction, and has the same size as the first winding portion 11. The second winding portion 12 has a second axis portion main body 12c, a second terminal end portion 12d as an end portion on one side in the circumferential direction about the coil axis L, and a second starting end portion 12e as an end portion on the other side in the circumferential direction about the coil axis L. In the second axis portion main body 12c, the second slit 12b is formed by the second starting end portion 12e and the second terminal end portion 12d facing each other. The second slit 12b has a shape in which the second axis portion main body 12c is cut along the coil axis orthogonal direction. In the second winding portion 12, the second starting end portion 12e is connected to the first terminal end portion 11d of the first winding portion 11 by the connecting portion 13. In addition, in the second winding portion 12, a second terminal portion 12f is provided in the second terminal end portion 12d.

In a state where the first winding portion 11 and the second winding portion 12 are spaced apart from each other along the coil axis L direction, the connecting portion 13 interconnects the first terminal end portion 11d of the first winding portion 11 and the second starting end portion 12e of the second winding portion 12 along the coil axis L direction. As a result, in the coil winding portion 10, electric currents in the same direction flow about the coil axis L from the first terminal portion 11f of the first winding portion 11 to the second terminal portion 12f of the second winding portion 12.

The insulating bobbin 20 is a coil insulating member insulating the coil winding portion 10 from the core members 30, other electronic components, and the like. The insulating bobbin 20 is formed of a resin excellent in heat resistance and rigidity and is formed of, for example, poly phenylene sulfide (PPS) resin. The insulating bobbin 20 is manufactured by resin injection molding and with a mold or the like. The insulating bobbin 20 is provided with a first insulating bobbin 21 as a first insulating member and a second insulating bobbin 22 as a second insulating member. The insulating bobbin 20 is assembled to the coil winding portion 10 by the first insulating bobbin 21 and the second insulating bobbin 22 pinching the coil winding portion 10 from both sides in the coil axis L direction.

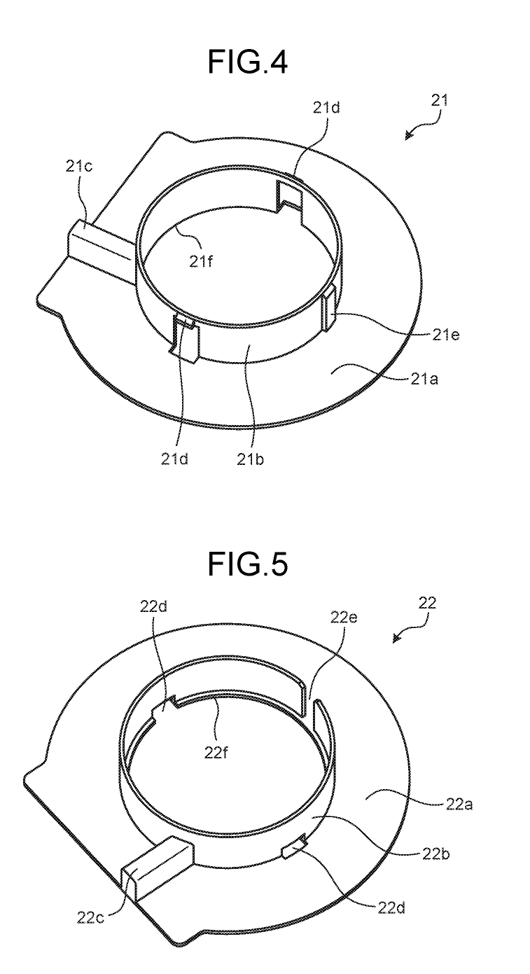

As illustrated in FIG. 4, the first insulating bobbin 21 has a first flange portion 21a as a first covering member, a first tube portion 21b, a first rib 21c as a first protruding portion, a pair of locking claw portions 21d as first locking portions, and a projecting portion 21e.

The first flange portion 21a is a member that covers the first annular end surface 11a, which is one end portion of the coil winding portion 10 in the coil axis L direction. The first flange portion 21a is formed in an annular and flat plate shape. For example, the first flange portion 21a extends along the coil axis orthogonal direction from one edge portion of the first tube portion 21b toward the outside of the first tube portion 21b. When viewed from the coil axis L direction, the first flange portion 21a overlaps with the first annular end surface 11a of the coil winding portion 10. The first flange portion 21a is formed such that the outer periphery of the first flange portion 21a is slightly larger than the outer periphery of the first annular end surface 11a.

The first tube portion 21b is a tubular member extending from an inner edge 21f of the first flange portion 21a to the coil winding portion 10 side along the coil axis L direction. The length of the first tube portion 21b in the coil axis L direction is approximately the same as the thickness of the coil winding portion 10 in the coil axis L direction. The first tube portion 21b is inserted inside the coil winding portion 10. Further, the first tube portion 21b is inserted inside a second tube portion 22b of the second insulating bobbin 22, which will be described later.

The first rib 21c is a protruding portion provided on the coil winding portion 10 side of the first flange portion 21a, that is, the first tube portion 21b side of the first flange portion 21a. The first rib 21c determines the relative positions of the first insulating bobbin 21 and the coil winding portion 10 in the circumferential direction of the coil axis L and is provided at a position that determines the relative positions. The first rib 21c protrudes along the coil axis L direction and is fitted into the first slit 11b.

The pair of locking claw portions 21d is locking portions locked in a pair of locking opening portions 22d of the second insulating bobbin 22, which will be described later. The pair of locking claw portions 21d is provided in the first tube portion 21b and is provided at positions corresponding to the pair of locking opening portions 22d of the second insulating bobbin 22. For example, the pair of locking claw portions 21d is provided at positions facing each other in the coil axis orthogonal direction on the outer peripheral surface of the first tube portion 21b. The pair of locking claw portions 21d is positioned in the end portion of the first tube portion 21b that is on the side opposite to the first flange portion 21a and protrudes in the coil axis orthogonal direction. The first tube portion 21b above the pair of locking claw portions 21d (on the first flange portion 21a side) is partially hollowed out so that the pair of locking claw portions 21d is easily bent to the inside of the first tube portion 21b in a case where the pair of locking claw portions 21d is locked in the pair of locking opening portions 22d.

The projecting portion 21e is to more accurately determine the relative positions of the first insulating bobbin 21 and the second insulating bobbin 22 and is provided at a position that determines the relative positions. For example, the projecting portion 21e is provided at a position that determines the position where the pair of locking claw portions 21d and the pair of locking opening portions 22d are locked. For example, the projecting portion 21e is provided on the outer peripheral surface of the first tube portion 21b, protrudes in the coil axis orthogonal direction, and is linearly formed from one end to the other end of the first tube portion 21b along the coil axis L direction. The projecting portion 21e is fitted into a third slit 22e of the second insulating bobbin 22, which will be described later.

As illustrated in FIG. 5, the second insulating bobbin 22 has a second flange portion 22a as a second covering member, the second tube portion 22b, a second rib 22c as a second protruding portion, the pair of locking opening portions 22d as second locking portions, and the third slit 22e.

The second flange portion 22a is a member that covers the second annular end surface 12a, which is the other end portion of the coil winding portion 10 in the coil axis L direction. The second flange portion 22a is formed in an annular and flat plate shape. For example, the second flange portion 22a extends along the coil axis orthogonal direction from one edge portion of the second tube portion 22b toward the outside of the second tube portion 22b. When viewed from the coil axis L direction, the second flange portion 22a overlaps with the second annular end surface 12a of the coil winding portion 10. The second flange portion 22a is formed such that the outer periphery of the second flange portion 22a is slightly larger than the outer periphery of the second annular end surface 12a.

The second tube portion 22b is a tubular member extending from an inner edge 22f of the second flange portion 22a to the coil winding portion 10 side along the coil axis L direction. The length of the second tube portion 22b in the coil axis L direction is approximately the same as the thickness of the coil winding portion 10 in the coil axis L direction. The second tube portion 22b is inserted inside the coil winding portion 10.

The second rib 22c is a protruding portion provided on the coil winding portion 10 side of the second flange portion 22a, that is, the second tube portion 22b side of the second flange portion 22a. The second rib 22c determines the relative positions of the second insulating bobbin 22 and the coil winding portion 10 in the circumferential direction of the coil axis L and is provided at a position that determines the relative positions. The second rib 22c protrudes along the coil axis L direction and is fitted into the second slit 12b.

The pair of locking opening portions 22d is locking portions locked with the locking claw portions 21d of the first insulating bobbin 21. The pair of locking opening portions 22d is provided in the second tube portion 22b and is provided at positions corresponding to the pair of locking claw portions 21d of the first insulating bobbin 21. For example, the pair of locking opening portions 22d is provided at positions facing each other in the coil axis orthogonal direction in the outer peripheral surface of the second tube portion 22b. The pair of locking opening portions 22d is positioned in the end portion of the second tube portion 22b that is on the second flange portion 22a side and is open in the coil axis orthogonal direction. The locking claw portions 21d are locked in the pair of locking opening portions 22d in a state where the first rib 21c is fitted into the first slit 11b and the second rib 22c is fitted into the second slit 12b.

The third slit 22e is to more accurately determine the relative positions of the first insulating bobbin 21 and the second insulating bobbin 22 in cooperation with the projecting portion 21e of the first insulating bobbin 21 and is provided at a position that determines the relative positions. For example, the third slit 22e is provided at a position that determines the position where the pair of locking claw portions 21d and the pair of locking opening portions 22d are locked in cooperation with the projecting portion 21e of the first insulating bobbin 21. For example, the third slit 22e is a cut portion provided in the main body (inner peripheral surface) of the second tube portion 22b and is linearly formed from one end to the other end of the second tube portion 22b along the coil axis L direction. The third slit 22e is fitted along the coil axis L direction into the projecting portion 21e of the first insulating bobbin 21 at the position where the pair of locking claw portions 21d and the pair of locking opening portions 22d are locked.

The pair of core members 30 is formed so as to include, for example, ferrite as a magnetic body with high magnetic permeability. A first core member 31 has a first base portion 31b having a main surface 31a, a first circular column portion 31c protruding in the coil axis L direction in the middle of the main surface 31a, and a pair of first pinching columns 31d provided across the first circular column portion 31c at both ends of the main surface 31a and protruding in the coil axis L direction. The first circular column portion 31c is formed such that the diameter of the first circular column portion 31c is shorter than the diameter of the first tube portion 21b and is inserted inside the first tube portion 21b in a state where the coil component 1 is placed on the main surface 31a of the first base portion 31b. The pair of first pinching columns 31d pinches the first insulating bobbin 21 side of the coil component 1 from the coil axis orthogonal direction in a state where the coil component 1 is placed on the main surface 31a of the first base portion 31b.

A second core member 32 has the same shape as the first core member 31 and has a second base portion 32b having a main surface 32a, a second circular column portion 32c protruding in the coil axis L direction in the middle of the main surface 32a, and a pair of second pinching columns 32d provided across the second circular column portion 32c at both ends of the main surface 32a and protruding in the coil axis L direction. The second circular column portion 32c is formed such that the diameter of the second circular column portion 32c is shorter than the diameter of the second tube portion 22b and is inserted inside the second tube portion 22b in a state where the coil component 1 is placed on the main surface 32a of the second base portion 32b. The pair of second pinching columns 32d pinches the coil component 1 from the coil axis orthogonal direction in a state where the coil component 1 is placed on the main surface 32a of the second base portion 32b. In a state where the pair of core members 31 and 32 is assembled to the coil component 1, the end surfaces of the pair of first pinching columns 31d in the coil axis L direction abut against the end surfaces of the pair of second pinching columns 32d in the coil axis L direction.

Next, a method for assembling the coil component 1 and the core member 30 will be described. The second tube portion 22b of the second insulating bobbin 22 is inserted inside the coil winding portion 10 from one side in the coil axis L direction and the second rib 22c of the second insulating bobbin 22 is fitted into the second slit 12b of the coil winding portion 10. Next, the first tube portion 21b of the first insulating bobbin 21 is inserted inside the coil winding portion 10 from the other side in the coil axis L direction. At this time, the projecting portion 21e of the first insulating bobbin 21 is fitted into the third slit 22e of the second insulating bobbin 22 inserted inside the coil winding portion 10. As a result, the relative positions of the first insulating bobbin 21 and the second insulating bobbin 22 are determined, and the pair of locking claw portions 21d and the pair of locking opening portions 22d can be aligned with ease. The pair of locking claw portions 21d is locked in the pair of locking opening portions 22d in a state where the first rib 21c of the first insulating bobbin 21 is fitted into the first slit 11b of the coil winding portion 10. As a result, the coil component 1 is assembled to the coil winding portion 10 in a state where the first and second insulating bobbins 21 and 22 are locked and the first and second ribs 21c and 22c suppress rotation of the first and second insulating bobbins 21 and 22 around the coil axis L with respect to the coil winding portion 10.

Next, the second circular column portion 32c of the second core member 32 is inserted inside the first and second tube portions 21b and 22b from one side in the coil axis L direction and the outer periphery of the second flange portion 22a of the second insulating bobbin 22 is partially pinched by the pair of second pinching columns 32d. Likewise, the first circular column portion 31c of the first core member 31 is inserted inside the first and second tube portions 21b and 22b from the other side in the coil axis L direction and the outer periphery of the first flange portion 21a of the first insulating bobbin 21 is partially pinched by the pair of first pinching columns 31d. At this time, the end surfaces of the pair of first pinching columns 31d in the coil axis L direction abut against the end surfaces of the pair of second pinching columns 32d in the coil axis L direction.

As described above, the coil component 1 and the insulating bobbin 20 according to the embodiment are provided with the first insulating bobbin 21 having the first flange portion 21a, the first rib 21c, and the pair of locking claw portions 21d and the second insulating bobbin 22 having the second flange portion 22a, the second rib 22c, and the pair of locking opening portions 22d. The pair of locking claw portions 21d and the pair of locking opening portions 22d are locked in a state where both end portions of the coil winding portion 10 in the coil axis L direction are covered with the first and second flange portions 21a and 22a and the first and second ribs 21c and 22c are respectively fitted into the first and second slits 11b and 12b of the coil winding portion 10. As a result, with the coil component 1 and the insulating bobbin 20, both end portions of the coil winding portion 10 in the coil axis L direction can be insulated from the core members 30, other electronic components, and the like by the first and second flange portions 21a and 22a. In addition, in the coil component 1 and the insulating bobbin 20, the first and second insulating bobbins 21 and 22 are assembled to the coil winding portion 10 in a state where the first rib 21c is fitted into the first slit 11b inevitably formed in the coil winding portion 10 and the second rib 22c is fitted into the second slit 12b inevitably formed in the coil winding portion 10, and thus it is possible to suppress rotation of the first and second insulating bobbins 21 and 22 around the coil axis L with respect to the coil winding portion 10 without processing of the coil winding portion 10 attributable to the first and second insulating bobbins 21 and 22. In addition, the first and second ribs 21c and 22c are respectively fitted into the first and second slits 11b and 12b in the coil component 1 and the insulating bobbin 20, and thus the relative positions of the first insulating bobbin 21 and the second insulating bobbin 22 around the coil axis L can be aligned and the first insulating bobbin 21 and the second insulating bobbin 22 can be easily locked by the pair of locking claw portions 21d and the pair of locking opening portions 22d. In this manner, the coil component 1 and the insulating bobbin 20 allow workability to be improved when the insulating bobbin 20 is assembled to the coil winding portion 10 while ensuring adequate insulation performance. In addition, the coil component 1 and the insulating bobbin 20 allow the configurations of the first and second insulating bobbins 21 and 22 to be simplified as two components constitute the insulating bobbin 20, one being the first insulating bobbin 21 and the other being the second insulating bobbin 22. As a result, the coil component 1 and the insulating bobbin 20 can be manufactured with ease, and thus cost reduction can be achieved.

In the coil component 1, the coil winding portion 10 is provided with the ended ring-shaped first winding portion 11 having the first slit lib formed by the first terminal end portion 11d as one end portion in the circumferential direction about the coil axis L and the first starting end portion 11e as the other end portion in the circumferential direction about the coil axis L, the ended ring-shaped second winding portion 12 having the second slit 12b formed by the second terminal end portion 12d as one end portion in the circumferential direction about the coil axis L and the second starting end portion 12e as the other end portion in the circumferential direction about the coil axis L, and the connecting portion 13 interconnecting the first terminal end portion 11d of the first winding portion 11 and the second starting end portion 12e of the second winding portion 12 along the coil axis L direction in a positional relationship in which the first winding portion 11 and the second winding portion 12 are spaced apart from each other along the coil axis L direction. As a result, with the coil winding portion 10, it is possible to determine the relative positions of the first and second insulating bobbins 21 and 22 with respect to the coil winding portion 10 without processing of the coil winding portion 10 attributable to the first and second insulating bobbins 21 and 22.

In the first insulating bobbin 21 and the second insulating bobbin 22 of the coil component 1, the first tube portion 21b is inserted inside the second tube portion 22b, the first tube portion 21b has the projecting portion 21e, the second tube portion 22b has the third slit 22e formed along the coil axis L direction, and the projecting portion 21e is fitted into the third slit 22e at the position where the pair of locking claw portions 21d and the pair of locking opening portions 22d are locked. As a result, in the coil component 1, the relative positions of the first insulating bobbin 21 and the second insulating bobbin 22 are determined and the pair of locking claw portions 21d and the pair of locking opening portions 22d can be aligned with ease.

### Modification Example

A modification example of the embodiment will be described below. The first and second insulating bobbins 21 and 22 may have the third slit 22e in the first tube portion 21b and may have the projecting portion 21e in the second tube portion 22b. As for the first and second insulating bobbins 21 and 22 in this case, the projecting portion 21e is fitted into the third slit 22e at the position where the pair of locking claw portions 21d and the pair of locking opening portions 22d are locked.

The first slit 11b may be configured to include the first terminal portion 11f and the connecting portion 13. The second slit 12b may be configured to include the second terminal portion 12f and the connecting portion 13.

The present invention is not limited to the above-described example in which the first tube portion 21b is inserted and locked inside the second tube portion 22b. For example, the first tube portion 21b and the second tube portion 22b may have tip portions abutting against each other in the coil axis L direction and a lock mechanism may be provided so that the first tube portion 21b and the second tube portion 22b are locked with the tip portions abutting against each other.

A coil component and a coil insulating member according to the present embodiment are provided with a first insulating member having a first covering member, a first protruding portion, and a first locking portion and a second insulating member having a second covering member, a second protruding portion, and a second locking portion. The first locking portion and the second locking portion are locked in a state where both end portions of a coil winding portion in a coil axis direction are covered with the first and second covering members and the first and second protruding portions are respectively fitted into first and second slits of the coil winding portion. As a result, the coil component and the coil insulating member allow workability to be improved when the coil insulating member is assembled to the coil winding portion while ensuring adequate insulation performance.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A coil component comprising:
a coil winding portion formed by a single conductor being wound more than once around a coil axis, a first slit being formed in one end portion of the coil winding portion in a coil axis direction along the coil axis and a second slit being formed in the other end portion of the coil winding portion in the coil axis direction by the conductor being wound;
a first insulating member including an annular first covering member covering the one end portion of the coil winding portion, a first tube portion extending from an inner edge of the first covering member to the coil winding portion side along the coil axis direction and inserted inside the coil winding portion, a first protruding portion provided on the coil winding portion side of the first covering member and fitted into the first slit, and a first locking portion provided in the first tube portion; and
a second insulating member including an annular second covering member covering the other end portion of the coil winding portion, a second tube portion extending from an inner edge of the second covering member to the coil winding portion side along the coil axis direction and inserted inside the coil winding portion, a second protruding portion provided on the coil winding portion side of the second covering member and fitted into the second slit, and a second locking portion provided in the second tube portion and locked in the first locking portion in a state where the first protruding portion is fitted into the first slit and the second protruding portion is fitted into the second slit.

2. The coil component according to claim 1, wherein
the coil winding portion includes:
a first winding portion formed in an ended ring shape and having the first slit formed by one end portion and the other end portion in a circumferential direction about the coil axis;
a second winding portion formed in an ended ring shape and having the second slit formed by one end portion and the other end portion in a circumferential direction about the coil axis; and
a connecting portion interconnecting the one end portion of the first winding portion and the other end portion of the second winding portion along the coil axis direction in a positional relationship in which the first winding portion and the second winding portion are spaced apart from each other along the coil axis direction.

3. The coil component according to claim 1, wherein
the first insulating member and the second insulating member are provided such that:
the first tube portion is inserted inside the second tube portion;
one of the first tube portion and the second tube portion has a projecting portion;
the other of the first tube portion and the second tube portion has a third slit formed along the coil axis direction; and
the projecting portion is fitted into the third slit at a position where the first locking portion and the second locking portion are locked.

4. The coil component according to claim 2, wherein
the first insulating member and the second insulating member are provided such that:
the first tube portion is inserted inside the second tube portion;
one of the first tube portion and the second tube portion has a projecting portion;
the other of the first tube portion and the second tube portion has a third slit formed along the coil axis direction; and
the projecting portion is fitted into the third slit at a position where the first locking portion and the second locking portion are locked.

5. A coil insulating member comprising:
a first insulating member including an annular first covering member covering one end portion of a coil winding portion, a first tube portion extending from an inner edge of the first covering member to the coil winding portion side along a coil axis direction and inserted inside the coil winding portion, a first protruding portion provided on the coil winding portion side of the first covering member and fitted into a first slit, and a first locking portion provided in the first tube portion, the coil winding portion being formed by a single conductor being wound more than once around a coil axis, the first slit being formed in the one end portion of the coil winding portion in the coil axis direction along the coil axis, and a second slit being formed in the other end portion of the coil winding portion in the coil axis direction by the conductor being wound; and
a second insulating member including an annular second covering member covering the other end portion of the coil winding portion, a second tube portion extending from an inner edge of the second covering member to the coil winding portion side along the coil axis direction and inserted inside the coil winding portion, a second protruding portion provided on the coil winding portion side of the second covering member and fitted into the second slit, and a second locking portion provided in the second tube portion and locked in the first locking portion in a state where the first protruding portion is fitted into the first slit an the second protruding portion is fitted into the second slit.
